(19) United States
(12) Patent Application Publication
(10) Pub. No.: US 2009/0307979 A1
(43) Pub. Date: Dec. 17, 2009

(54) TILT LATCH

(76) Inventor: Glen Wolf, Owatonna, MN (US)

Correspondence Address: PATTERSON, THUENTE, SKAAR & CHRISTENSEN, P.A., 4800 IDS CENTER, 80 SOUTH 8TH STREET, MINNEAPOLIS, MN, 55402-2100, US

(21) Appl. No.: 12/137,161

(22) Filed: Jun. 11, 2008

(51) Int. Cl. E05D 15/22; E05C 5/00

(52) U.S. Cl. 49/181; 292/5; 49/506

(57) ABSTRACT

A latch including a first housing portion, a second housing portion and a bolt therebetween. A plurality of tabs may extend from the base, the plurality of tabs extending outwardly beyond the side walls when the side walls are operably coupled with the at least a portion of the second housing portion. One or more retention structures may be provided on the outer portion of the housing to inhibit longitudinal movement of the latch assembly within a recess in a window sash when the latch is installed in the recess.

### FIELD

The present invention relates generally to windows. More particularly, the embodiments of the present invention relate to a tilt latch for windows.

### BACKGROUND

Double-hung windows include two window sashes mounted for vertical movement along adjacent parallel tracks included in a window jamb. Conventional double-hung window designs can be difficult to wash, as it can be difficult for a person located inside a room to wash the outside of the window pane. To fully wash the outer surface, the person cleaning the window can have to move to a position outside the dwelling, often requiring the use of a ladder for upper-level windows. Such cleaning is further complicated where there are screens or storm windows which must be removed prior to washing.

Tilt latches have been included on double-hung window in opposite ends of a top horizontal rail of the upper and/or lower sash. These latches often include a bolt, which extends out from the side of the sash into the sash track in the window frame to guide the sash for typical vertical movement. The bolt of each latch can retract in some manner when washing is desired to free the top rail of the sash from the track so that the sash can be pivoted inwardly, thereby enabling the washer to easily reach the outside surface of the window pane of that sash.

Examples of some tilt latches are described in U.S. Pat. No. RE37,916. The latches described therein can be installed by being snapped into position when forced perpendicularly through an elongated opening in a sash. To enable a bolt of the tilt latch be moved between engaged and disengaged positions, a pair of wings is provided on the bolt and corresponding slots are included on the latch housing. In use, because there is clearance or play enabling at least limited sideways movement of the bolt within the housing, the bolt may be misaligned with respect to a corresponding recess in a window jamb.

There is therefore a need for improved tilt latch mechanisms.

### BRIEF SUMMARY

The tilt latch according to embodiments herein can overcome the above-referenced deficiencies. In an embodiment, the tilt latch includes a first track portion on a portion of latch housing and a corresponding second track portion on a portion of a bolt. The first and second track portions can enable the bolt to be moved between engaged and disengaged positions, while inhibiting play or sideways movement of the bolt within the housing. Further, in an embodiment, the tilt latch can include structure enabling assembly by being snapped or otherwise placed into position when moved perpendicularly into an elongated opening in a sash.

In an aspect, a latch includes a first housing portion including a cover having a pair of side walls extending therefrom, a second housing portion having a base presenting a first track portion thereon, the side walls being operably coupleable with at least a portion of the second housing portion to couple the first housing portion with respect to the second housing portion to present a cavity therebetween, a plurality of tabs extending from the base, the plurality of tabs extending outwardly beyond the side walls when the side walls are operably coupled with the at least a portion of the second housing portion, and a latch bolt positionable in the cavity and movable between an engaged position and a disengaged position.

In another aspect, a window includes a sash frame having an opening therein and a tilt latch presented in the opening. The tilt latch can include a first housing portion including a cover having a pair of side walls extending therefrom, a second housing portion having a base presenting a first track portion thereon, the side walls being operably coupleable with the second housing portion to couple the first housing portion with respect to the second housing portion to present a cavity therebetween, a plurality of tabs extending from the base, the plurality of tabs extending outwardly beyond the side walls when the side walls are operably coupled with the base, and a latch bolt positionable in the cavity and movable between an engaged position and a disengaged position.

In yet another aspect, a method of forming a tilt latch includes providing an upper housing portion including a cover having a pair of side walls extending therefrom, providing a lower housing portion having a base presenting a track portion thereon and a plurality of tabs extending from the base, providing a latch bolt and a biasing element, and coupling the first housing portion with respect to the second housing portion with the latch bolt positioned in a cavity formed therebetween, such that the plurality of tabs extend outwardly beyond the side walls and the latch bolt is slidably movable on the track portion and biased towards an engaged position.

### BRIEF DESCRIPTION OF THE DRAWINGS

FIG. 1 is exploded top perspective view of a latch according to an embodiment;

FIG. 2 is a bottom perspective view of an upper housing portion of the latch of FIG. 1;

FIG. 3 is an assembled top plan view of the latch of FIG. 1;

FIG. 4 is an assembled side elevational view of the latch of FIG. 1;

FIG. 5 is an assembled front elevational view of the latch of FIG. 1;

FIG. 6 is a perspective view of a window assembly including the latch of FIG. 1;

FIG. 7 is a fragmentary perspective view of the window assembly of FIG. 6, including the latch of FIG. 1;

FIG. 8 is an assembled side elevational view of the latch of FIG. 1, depicting the latch in a window assembly;

FIG. 9 is exploded top perspective view of a latch according to another embodiment;

FIG. 10 is a top perspective view of a bottom housing portion of the latch of FIG. 9;

FIG. 11 is an assembled top plan view of the latch of FIG. 9;

FIG. 12 is an assembled side elevational view of the latch of FIG. 9;

FIG. 13 is an assembled front elevational view of the latch of FIG. 9;

FIG. 14 is an assembled side elevational view of the latch of FIG. 9, depicting the latch in a window assembly;

FIG. 15 is a bottom perspective view of the bolt portion of the latch of FIG. 9;

FIG. 16 is a bottom perspective view of the bottom portion of the housing of the latch of FIG. 9; and

FIG. 17 is an assembled top perspective view of the latch of FIG. 9.

### DETAILED DESCRIPTION OF THE DRAWINGS

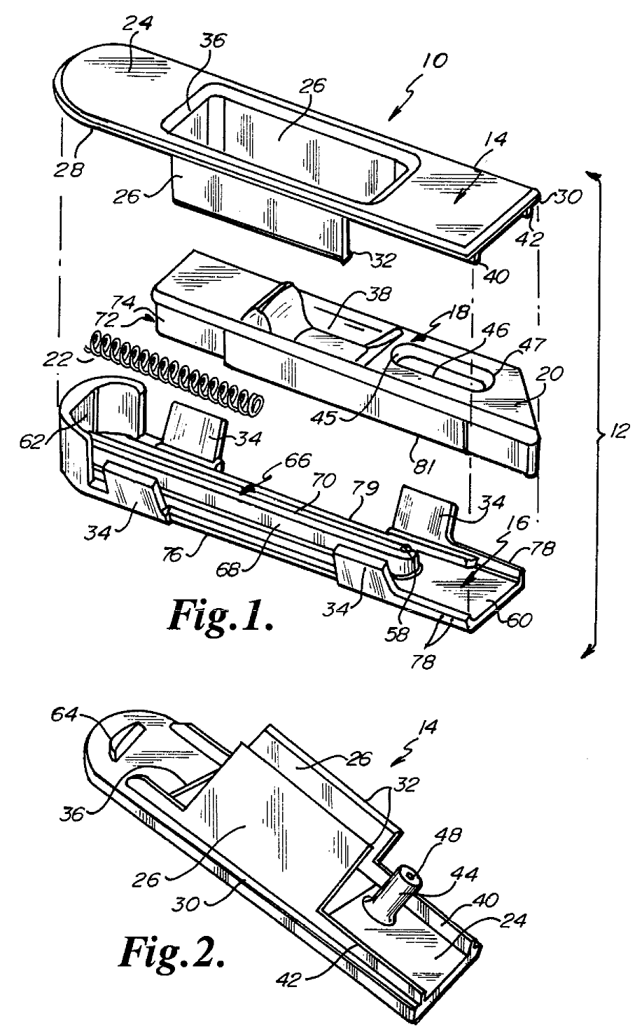

Referring to FIG. 1, a tilt latch 10 generally includes a latch housing 12 having a first, upper portion 14 and a second, lower portion 16, a bolt 18 having a nose 20 presented thereon, and a biasing member or element 22, such as a coil spring.

First portion 14 comprises a cover 24 having first and second side walls 26 depending therefrom. Side walls 26 can depend from a window or opening 36 presented on cover 24 and can be at a distance inward from an outer edge 28 of cover 24 to present a ledge 30 on an underside of cover 24. Each of side walls 26 can include a lip 32 thereon on an end distal from cover 24 for coupling first portion 14 with respect to second portion 16. Side walls 26 are operably coupleable with a base 60 of second portion 16 to couple first portion 14 with respect to second portion 16, such that a plurality of tabs 34 included on base 60 extend outwardly beyond side walls 26 (see FIG. 5).

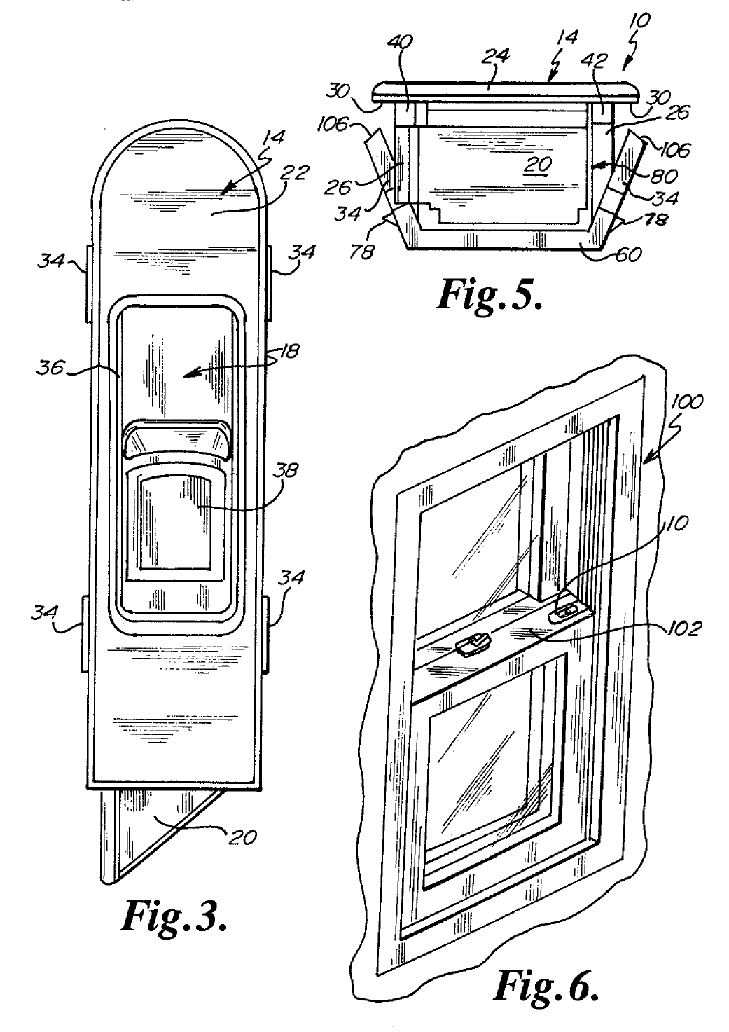

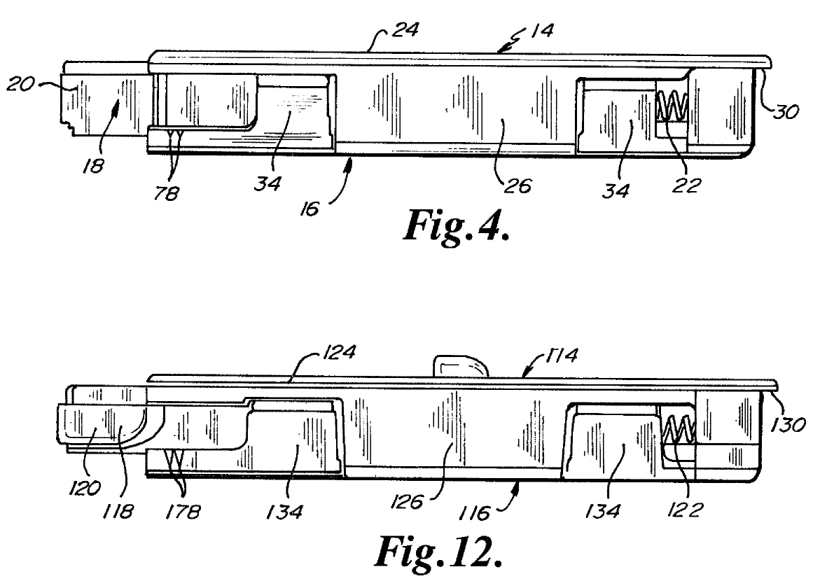

Referring to FIGS. 3 and 4. window 36 presented on cover 24 can expose a recess 38 or other structure on bolt 18 that can be used for effecting movement of bolt 18 between engaged and disengaged positions.

Referring again to FIG. 2, first portion 14 can comprise a first rail 40 and a second rail 42 presented on an underside of cover 24 and extending along substantially an entire length thereof for maintaining alignment of latch 10 when positioned in a sash 100 of a window assembly (see FIGS. 6-8), in conjunction with ledge 30.

Referring to FIGS. 1 and 2, a post 44 or other member can be presented on an underside of cover 24 that is operable with an elongate aperture 46 that can be included on bolt, thus enabling bolt 18 to be moved between engaged and disengaged positions, elongate aperture 46 also limiting movement of bolt 18 between the engaged and disengaged positions. Post 44 can comprise an aperture or recess 48 therein that can be coupleable with a projection 58 that can be included on an upper side of a base 60 of second portion 16.

Referring again to FIG. 1, second portion 16 includes a base 60 having one or more tabs 34 extending upwardly and outwardly therefrom. Second portion 16 can further include an end wall 62 depending upwardly from base 60 transverse to said side walls 26 when first portion 14 is coupled relative to second portion 16. In another embodiment, end wall 62 can depend downwardly from cover 24 transverse to said side walls 26.

Referring again to FIG. 2, a lip 64 can be included on an underside of cover 24 that is engageable with end wall 62 to align first portion 14 of housing 12 with second portion 16 of housing 12. Such alignment can be in addition to any alignment provided by coupling side walls 26 with base 60.

Referring to FIG. 1, second portion 16 can further include a first track portion 66 presented on base 60, such that bolt 18 is slidable relative to first track portion 66 between engaged and disengaged positions. First track portion 66 can comprise first and second rails 68, 70 engageable with guides 74 included as part of a second track portion 72 on an underside of bolt. One of a pair of guides 74 is depicted in FIG. 1.

Second portion 16 can further include a pair of recesses 76 (one depicted) on sides of base 60. When first portion 14 is coupled relative to second portion 16, lips 32 on sidewalls 26 can engage recesses 76, securing first portion 14 with respect to second portion 16.

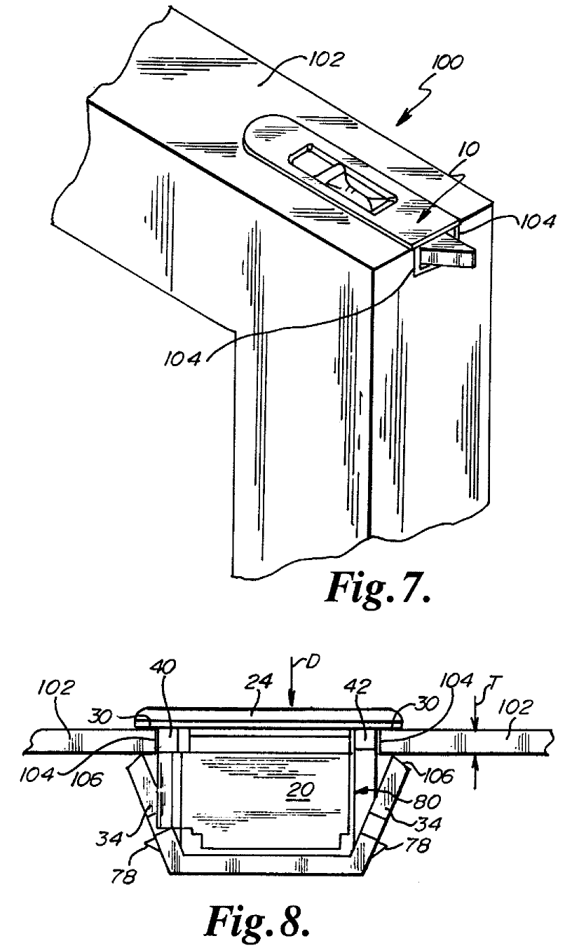

In an embodiment, second portion 16 can include a retention feature, such as a plurality of projections 78 extending from an outer edge of base. Projections 78 can be operable with at least a portion of sash 102 (see FIG. 7) to inhibit horizontal movement of latch 10 when coupled with a recess 104 in a sash 102 of a window assembly 100. The side location of projections 78 alleviates the problem of interference with other structure internal to the window sash, a problem present in many prior art window latches having retention structure projecting from the bottom of the latch.

Referring to FIG. 1, second portion 16 can further include a pair of opposed steps 79 (one depicted), along at least a portion of a length thereof, that can correspond to a pair of opposed bevels 81 (one depicted) included on an underside of bolt 18. When assembled, steps 79 can assist in guiding movement of said bolt 18 by acting as a tracking feature for bevels 81.

Referring to FIGS. 5 and 8, a cavity 80 or opening is presented between first and second housing portions 14, 16 and side walls 26 when first portion 14 is coupled with respect to second portion 16. Bolt 18 is positionable in cavity 80 such that post 44 extends through elongate aperture 46 and is coupled with projection 58. In this configuration, bolt 18 is movable between engaged and disengaged positions. Such movement can be limited at extremes of engaged and disengaged positions by post 44 interacting with ends 45, 47 of elongate aperture. Biasing member 22 can be positioned between bolt 18 and end wall 62 in cavity 80. Biasing member can bias bolt 18 in the engaged position.

To assemble latch, biasing member 22 is coupled with bolt 18 and the spring/bolt assembly is placed onto base 60 of first portion 16, such that guides 74 of second track portion 72 are on either side of rails 68, 70 of first track portion 66 and projection 58 at an end of first track portion 66 is presented in elongate aperture 46. To couple first portion 14 relative to second portion 16, lips 32 on side walls 26 are positioned and engaged with recesses 76, securing first portion 14 with respect to second portion 16. In this configuration, post 44 extends through elongate aperture 46 and engages with projection 58.

Referring to FIGS. 6-8, once assembled, latch 10 can be placed into a recess 104 in a sash 102 of a window assembly 100. To do so, latch 10 can be moved along direction “D” (FIG. 8) into recess 104, until ledge 30 rests on opposing sides of recess. As latch 10 is moved into recess 104, tabs 34 are flexed inwardly as they are moved past recess 104 structure. An example window assembly is described further in U.S. Patent Publication No. 2007/0029810, which is incorporated by reference in its entirety herein.

Once the tops of tabs 34 are moved past recess 104 structure, tabs 34 flex back into their original shape. In this configuration, tabs 34 inhibit removal of latch 10 from recess 104. Further, in embodiments of the invention as depicted in FIGS. 5 and 8, the tops of tabs 34 present beveled surface 106. Beveled surface 106 enables compensation for variation in sash wall thickness T by enabling tabs 34 to flex more for thinner sash walls and less for thicker sash walls while still inhibiting removal of latch 10 from recess 104. In certain embodiments, tabs 34 may compensate for sash wall thicknesses in a range from about 0.060 inch to about 0.080 inch. First and second rails 40, 42 can inhibit sideways movement of latch 10 within recess 104. Projections 78 extending from outer edge of base 60 can be operable with at least a portion of recess 104 to inhibit movement of latch 10 when coupled with recess 104.

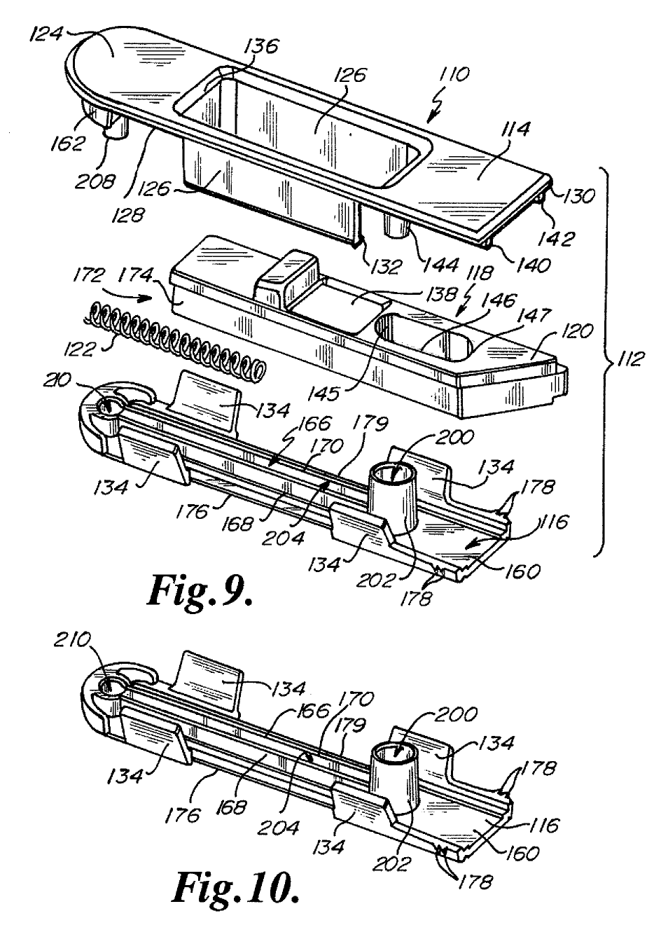

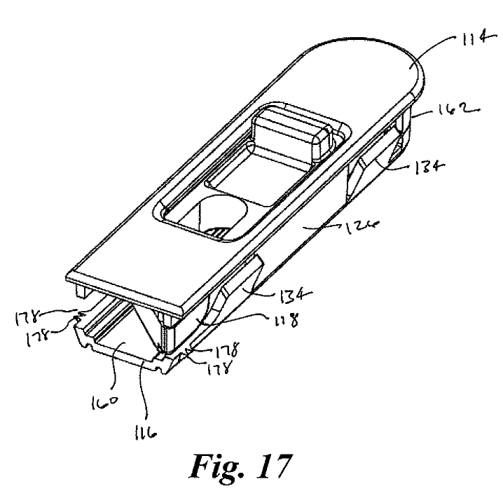

Referring now to FIGS. 9-17, a second embodiment of a tilt latch 110 generally includes a latch housing 112 having a first, upper portion 114 and a second, lower portion 116, a bolt 118 having a nose 120 presented thereon, and a biasing member or element 122, such as a coil spring.

First portion 114 generally includes a cover 124 having first and second side walls 126 depending therefrom. Side walls 126 can depend from a window or opening 136 presented on cover 124 and can be at a distance inward from an outer edge 128 of cover 124 to present a ledge 130 on an underside of cover 124. Each of side walls 126 can include a lip 132 thereon on an end distal from cover 124 for coupling first portion 114 with respect to second portion 116. Side walls 126 are operably coupleable with a base 160 of second portion 116 to couple first portion 114 with respect to second portion 116, such that a plurality of tabs 134 included on base 160 extend outwardly beyond side walls 126 (see FIG. 13). Post 208 extends downwardly from cover 124.

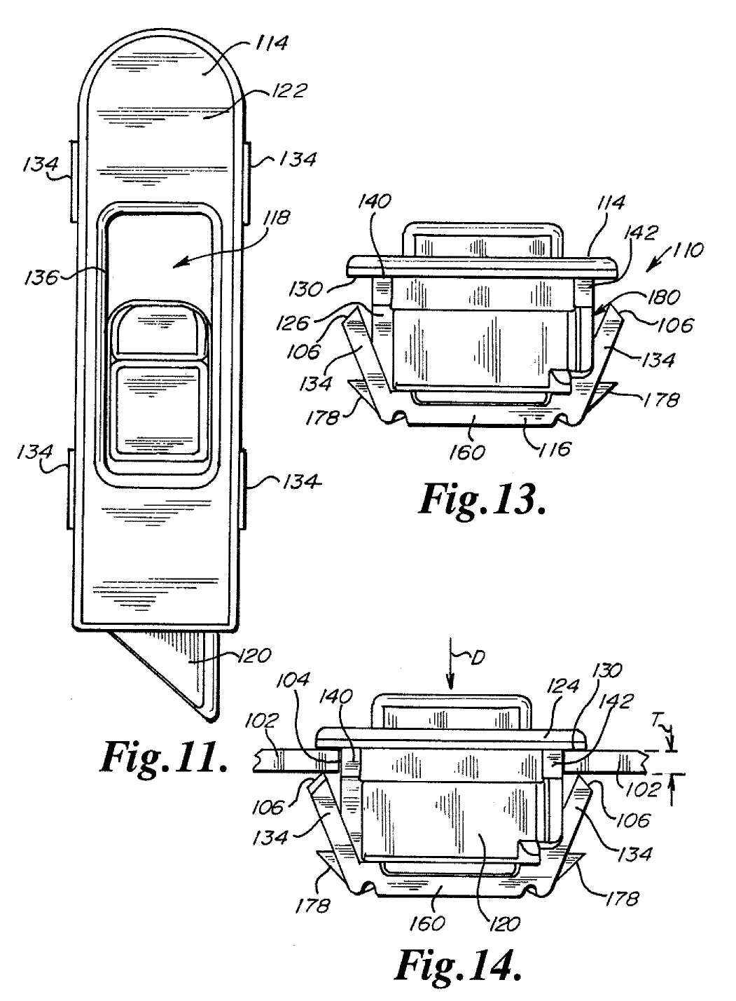

Referring to FIGS. 9 and 11, window 136 presented on cover 124 can expose a recess 138 or other structure on bolt 118 that can be used for effecting movement of bolt 118 between engaged and disengaged positions. First portion 114 generally includes a first rail 140 and a second rail 142 presented on an underside of cover 124 and extending along substantially an entire length thereof for maintaining alignment of latch 110 when positioned in a sash 100 of a window assembly, in conjunction with ledge 130.

Referring to FIGS. 9 and 10, a post 144 or other member can be presented on an underside of cover 124 that fits within bore 200 of projecting post 202 of second portion 116. Advantageously, this arrangement creates a double shear cross-section through post 144 and post 202 which strengthens the assembly substantially when load is applied to bolt 118 in use. Post 202 is operable with an elongate aperture 146 that can be included on bolt, thus enabling bolt 118 to be moved between engaged and disengaged positions, elongate aperture 146 also limiting movement of bolt 118 between the engaged and disengaged positions. Second portion 116 includes a base 160 having one or more tabs 134 extending upwardly and outwardly therefrom.

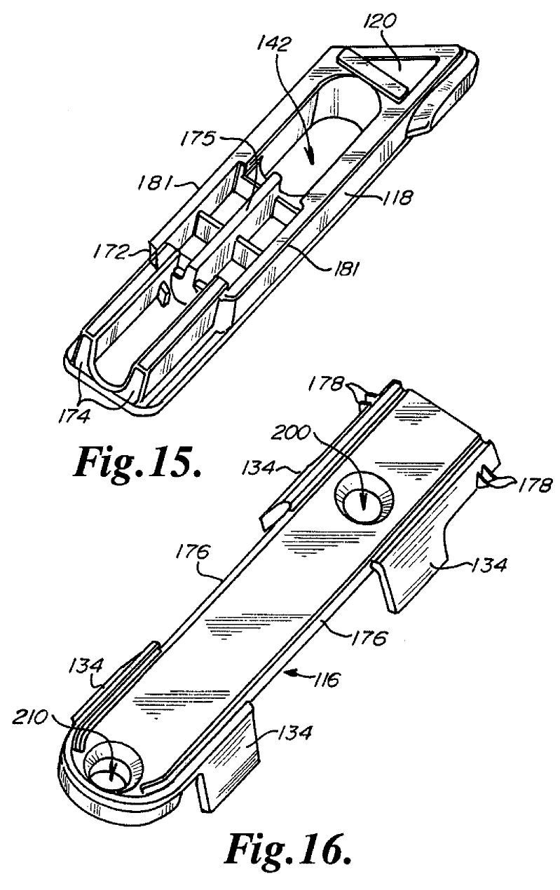

Referring to FIGS. 9 and 15, second portion 116 can further include a first track portion 166 presented on base 160, such that bolt 118 is slidable relative to first track portion 166 between engaged and disengaged positions. First track portion 166 generally includes first and second rails 168, 170 engageable with guides 174 and center guide 175 included as part of a second track portion 172 on an underside of bolt 118. As depicted in FIG. 16, second portion 116 can further include a pair of recesses 176 on sides of base 160. When first portion 114 is coupled relative to second portion 116, lips 132 on sidewalls 126 can engage recesses 176, securing first portion 114 with respect to second portion 116. Second portion 116 defines aperture 210.

In an embodiment, second portion 116 can include a retention feature, such as a plurality of projections 178 extending from an outer edge of base. Projections 178 can be operable with at least a portion of sash 102 (see FIG. 7) to inhibit horizontal movement of latch 110 when coupled with a recess 104 in a sash 102 of a window assembly 100. Although two projections 178 on each side are depicted, it will be appreciated that a single projection or any other number of projections may be included in other embodiments.

Referring to FIGS. 9 and 15, second portion 116 can further include a pair of opposed steps 179 (one depicted), along at least a portion of a length thereof, that can correspond to a pair of opposed bevels 181 included on an underside of bolt 118. When assembled, steps 179 confront bevels 181 and can assist in guiding movement of said bolt 118 by acting as a tracking feature for bevels 181.

Referring to FIGS. 13 and 14, a cavity 180 or opening is presented between first and second housing portions 114, 116 and side walls 126 when first portion 114 is coupled with respect to second portion 116. Bolt 118 is movable between engaged and disengaged positions. Such movement can be limited at extremes of engaged and disengaged positions by post 202 interacting with ends 145, 147 of elongate aperture. Biasing member 122 can be positioned between bolt 118 and end wall 162 in cavity 180. Biasing member can bias bolt 118 toward the engaged position.

To assemble latch, biasing member 122 is coupled with bolt 118 and the spring/bolt assembly is placed onto base 160 of first portion 116, such that guides 174 of second track portion 172 are on either side of rails 168, 170 of first track portion 166 and center guide 175 engaged in slot 204. To couple first portion 114 relative to second portion 116, lips 132 on side walls 126 are positioned and engaged with recesses 176, temporarily securing first portion 114 with respect to second portion 116. In this configuration, post 202 extends through elongate aperture 146 and post 144 is received in bore 200. In this position posts 202 and 210 are staked in place to permanently secure first portion 114 to second portion 116.

Referring to FIGS. 6, 7 and 14, once assembled, latch 110 can be placed into a recess 104 in a sash 102 of a window assembly 100. To do so, latch 110 can be moved along direction “D” into recess 104, until ledge 130 rests on opposing sides of recess. As latch 110 is moved into recess 104, tabs 134 are flexed inwardly as they are moved past recess 104 structure.

Once the tops of tabs 134 are moved past recess 104 structure, tabs 134 flex back into their original shape. In this configuration, tabs 34 inhibit removal of latch 10 from recess 104. Further, in embodiments of the invention as depicted in FIGS. 13 and 14, the tops of tabs 134 present beveled surface 106. Beveled surface 106 enables compensation for variation in sash wall thickness T by enabling tabs 134 to flex more for thinner sash walls and less for thicker sash walls while still inhibiting removal of latch 110 from recess 104. First and second rails 140, 142 can inhibit sideways movement of latch 110 within recess 104. Projections 178 extending from outer edge of base 160 can be operable with at least a portion of recess 104 to inhibit movement of latch 110 when coupled with recess 104.

The embodiments above are intended to be illustrative and not limiting. Additional embodiments are encompassed within the scope of the claims. Although the present invention has been described with reference to particular embodiments, those skilled in the art will recognize that changes may be made in form and detail without departing from the spirit and scope of the invention. For purposes of interpreting the claims for the present invention, it is expressly intended that the provisions of Section 112, sixth paragraph of 35 U.S.C. are not to be invoked unless the specific terms “means for” or “step for” are recited in a claim.

What is claimed is:

1. A latch comprising:
a first housing portion comprising a cover having a pair of side walls extending therefrom;
a second housing portion having a base presenting a first track portion thereon, said side walls being operably coupleable with at least a portion of said second housing portion to couple said first housing portion with respect to said second housing portion to present a cavity therebetween;
a plurality of tabs extending from said base, said plurality of tabs extending outwardly beyond said side walls when said side walls are operably coupled with said at least a portion of said second housing portion; and
a latch bolt positionable in said cavity and movable between an engaged position and a disengaged position.

2. The latch of claim 1, further comprising a second track portion presented on said latch bolt, said second track portion slidably operable with said first track portion when said latch bolt is positioned in said cavity enabling said latch bolt to be movable between said engaged and disengaged positions.

3. The latch of claim 2, wherein said second track portion comprises a pair of guides slidably operable with said first track portion.

4. The latch of claim 2, wherein said first and second track portions are contained entirely within said cavity when said first housing portion is coupled with respect to said second housing portion

5. The latch of claim 1, further comprising:
an elongate aperture presented along a length of said latch bolt; and
a post extending into said elongate aperture, wherein said elongate aperture is movable relative to said post when said latch bolt is positioned in said cavity, said post limiting a range of movement of said latch bolt to be between engaged and disengaged positions.

6. The latch of claim 1, further comprising an end wall presented with said first and second housing portions and a biasing element positioned between said latch bolt and said end wall in said cavity, said biasing element biasing said latch bolt towards said engaged position.

7. The latch of claim 6, wherein said end wall extends from said base.

8. The latch of claim 1, wherein said second track portion comprises a pair of guides slidably operable with said first track portion, said biasing element coupleable with said latch bolt, such that at least a portion of said biasing element is positioned intermediate said pair of guides.

9. The latch of claim 1, wherein each of said side walls comprise a lip thereon and said base comprises a pair of recesses thereon, said lips operably engageable with said recesses to couple said first housing portion with respect to said second housing portion

10. The latch of claim 1, wherein said first housing portion is at a position upward relative to said second housing portion, such that said side walls extend downwardly from said cover and said plurality of tabs extending upwardly from said base.

11. The latch of claim 1, wherein said plurality of tabs comprises a first pair of tabs and a second pair of tabs, wherein a first side wall of said pair of side walls is positioned intermediate said first pair of tabs when said side walls are operably coupled with said at least a portion of said second housing portion, and wherein a second side wall of said pair of side walls is positioned intermediate said second pair of tabs when said side walls are operably coupled with said at least a portion of said second housing portion.

12. The latch of claim 1, further comprising a pair of steps presented with said base and a pair of corresponding bevels provided with said bolt, wherein said steps and bevels provide guidance to said latch bolt for movement between said engaged and disengaged positions.

13. A window comprising:
a sash frame having an opening therein; and
a tilt latch presented in said opening, said tilt latch comprising:
a first housing portion comprising a cover having a pair of side walls extending therefrom;
a second housing portion having a base presenting a first track portion thereon, said side walls being operably coupleable with said second housing portion to couple said first housing portion with respect to said second housing portion to present a cavity therebetween;
a plurality of tabs extending from said base, said plurality of tabs extending outwardly beyond said side walls when said side walls are operably coupled with said base; and
a latch bolt positionable in said cavity and movable between an engaged position and a disengaged position.

14. The latch of claim 13, further comprising:
an elongate aperture presented along a length of said latch bolt; and
a post extending into and movable along said elongate aperture when said latch bolt is positioned in said cavity, wherein said post limits a range of movement of said latch bolt to be between engaged and disengaged positions.

15. The latch of claim 13, further comprising an end wall extending from said base and a biasing element positioned between said latch bolt and said end wall in said cavity, said biasing element biasing said latch bolt towards said engaged position.

16. The latch of claim 13, wherein each of said side walls comprise a lip thereon and said base comprises a pair of recesses thereon, said lips operably engageable with said recesses to couple said first housing portion with respect to said second housing portion

17. The latch of claim 13, wherein said first housing portion is at a position upward relative to said second housing portion, such that said side walls extend downwardly from said cover and said plurality of tabs extending upwardly from said base.

18. The latch of claim 13, wherein said plurality of tabs comprises a first pair of tabs extending upwardly from said base and a second pair of tabs extending upwardly from said base, wherein a first side wall of said pair of side walls is positioned intermediate said first pair of tabs when said side walls are operably coupled with said at least a portion of said second housing portion, and wherein a second side wall of said pair of side walls is positioned intermediate said second pair of tabs when said side walls are operably coupled with said at least a portion of said second housing portion.

19. A method of forming a tilt latch, said method comprising:
providing an upper housing portion comprising a cover having a pair of side walls extending therefrom;
providing a lower housing portion having a base presenting a track portion thereon and a plurality of tabs extending from said base;
providing a latch bolt and a biasing element; and
coupling said first housing portion with respect to said second housing portion with said latch bolt positioned in a cavity formed therebetween, such that said plurality of tabs extend outwardly beyond said side walls and said latch bolt is slidably movable on said track portion and biased towards an engaged position.

20. The method of claim 18, wherein each of said side walls comprise a lip thereon and said base comprises a pair of recesses thereon, said method further comprising:
operably engaging said pair of lips with said pair of recesses to couple said first housing portion with respect to said second housing portion.
